(19) United States
(12) Patent Application Publication
(10) Pub. No.: US 2009/0113752 A1
(43) Pub. Date: May 7, 2009

(54) Method of and System for Controlling a Kiln

(75) Inventor: Gregory Warren Weir, Victoria (AU)

Correspondence Address: HARNESS, DICKEY & PIERCE, P.L.C., P.O. BOX 828, BLOOMFIELD HILLS, MI, 48303, US

(73) Assignee: Australian Choice Timber Supplies Pty Ltd Factory 6, Kilsyth, Victoria (AU)

(21) Appl. No.: 11/992,869

(22) PCT Filed: Sep. 29, 2006
(86) PCT No.: PCT/AU2006/001424

§ 371 Date: Dec. 18, 2008

(30) Foreign Application Priority Data
Sep. 30, 2005 (AU) 2005905414

(51) Int. Cl. F26B 3/00; F26B 25/22

(52) U.S. Cl. 34/282; 34/524

(57) ABSTRACT

A system (110) for drying a charge of lumber includes a kiln (112), one or more sensors (114) for sensing the one or more monitored conditions associated with the operation of the kiln (112) when drying the charge of lumber; and a control system (116) for controlling the operation of the kiln (112) and the one or more sensors (114). The control system (116) is responsive to the one or more sensors (114) and is arranged to recognise a predetermined change in the one or more conditions and to control the operation of the kiln (112) by adjusting one or more kiln drying parameters in a manner predetermined by the nature of the change.

### FIELD OF THE INVENTION

This present invention relates to a method of, and system for, controlling a kiln to dry lumber.

While the present invention will be described hereinafter with particular reference to a method of and system for controlling a kiln to dry lumber or timber that uses solar energy or ultraviolet radiation to provide part or all of the heat for drying the lumber, it will be understood that forms of the present invention may be applicable to other types of kilns. For example, forms of the present invention may be applicable to a kiln including an alternative or supplementary heating system, such as a gas, steam or electrical heating system, that is able to be used when solar heating is either not available or is inadequate.

This present application claims priority to Australian Provisional Application No 2005905414, the full disclosure of which is incorporated herein by reference.

### BACKGROUND TO THE INVENTION

When drying one or more stacks of lumber or timber (hereinafter referred to as a charge of lumber) within a kiln according to a previously proposed drying prescription, a fixed drying schedule prescribing kiln drying parameters is followed, either manually by a kiln operator or automatically by a control system associated with the kiln. Such fixed drying schedules typically prescribe a progressive sequence of fixed steps, with each step prescribing a progressively harsher or more severe drying condition by progressively increasing the prescribed operating temperature and decreasing the prescribed relative humidity level within a drying chamber of the kiln. The duration of each step, and therefore when to advance to the next step, may be determined by scheduled time settings or when the mass of the lumber reaches predetermined levels, for example.

According to a further aspect of the present invention, there is provided a system for drying a charge of lumber according to the method defined in the immediately preceding paragraph, the system including:
a kiln;
one or more sensors for sensing the one or more monitored conditions associated with the operation of the kiln when drying the charge of lumber; and
a control system for controlling the operation of the kiln and the one or more sensors, the control system being responsive to the one or more sensors, the control system being arranged to recognise the predetermined change in the one or more conditions and to control the operation of the kiln by adjusting the one or more kiln drying parameters in a manner predetermined by the nature of the change.

The one or more monitored conditions may include at least one of ambient temperature, ambient humidity, ambient solar radiation, ambient light intensity, ambient wind speed, ambient barometric pressure, kiln temperature, kiln humidity, kiln air circulation speed, moisture content within the charge of lumber, and drying rate of the charge of lumber.

The one or more kiln drying parameters may include at least one of prescribed kiln temperature, prescribed kiln humidity, prescribed kiln over-temperature limit, prescribed kiln air circulation speed, and prescribed target drying rate.

Prescribed values for the predetermined change and the one or more kiln drying parameters may be represented in one or more tables in which the prescribed values can be stored and from which the prescribed values can be retrieved.

Preferably, the adjusting of the one or more kiln drying parameters includes switching the operation of the kiln between at least two substantially different phases, each phase being controlled by one or more prescribed kiln drying parameters to influence the adsorption and/or absorption of moisture by the charge of lumber. The at least two substantially different phases preferably include at least a first drying phase and at least one of a first equalisation phase and a first reconditioning phase, the drying phase being controlled by one or more prescribed kiln drying parameters which promote drying of the charge of lumber, the equalisation phase being controlled by one or more prescribed kiln drying parameters which promote reduced drying of and/or increased moisture adsorption by the charge of lumber relative to the drying phase, and the reconditioning phase being controlled by one or more prescribed kiln drying parameters which substantially cease or reverse the drying of the charge of lumber so as to facilitate the redistribution of moisture remaining within the charge of lumber.

Preferably, the kiln is a hybrid kiln operable in at least a solar mode in which the kiln operates to dry the charge of lumber substantially solely with heat generated from solar energy and a heated mode in which the kiln operates to dry the charge of lumber substantially solely with heat generated from means other than solar energy, and the adjusting of the one or more kiln drying parameters includes switching the operation of the kiln between the solar mode and the heated mode. The means other than solar energy may be a supplementary heating system, the supplementary heating system including at least one of a gas heating system, a steam heating system and an electrical heating system.

Preferably, the kiln is further operable in a multi-mode in which the kiln operates to dry the charge of lumber with heat generated from solar energy or with heat generated from the means other than solar energy or with a combination of heat generated from solar energy and heat generated from the means other than solar energy, and the adjusting of the one or more kiln drying parameters includes switching the operation of the kiln between the multi-mode and at least one of the solar mode and the heated mode.

Preferably, the one or more kiln drying parameters include prescribed target drying rate, prescribed kiln temperature and prescribed over-temperature limit, the prescribed over-temperature-limit being associated with a temperature at which components associated with the kiln may be harmed or the lumber may experience degrade, the prescribed over-temperature limit temperature not being less than the prescribed kiln temperature, and the method further includes allowing the temperature within the kiln to exceed the prescribed kiln temperature to effect a harsher drying rate within the kiln than the prescribed target drying rate and limiting the kiln temperature to at or below the over-temperature limit.

Preferably, the one or more kiln parameters include prescribed target drying rate, the one or more monitored conditions include drying rate of the charge of lumber over one or more predetermined time periods, a respective predetermined maximum drying rate is associated with each of the one or more time periods, and the method further includes changing or allowing to change a drying condition within the kiln to effect a harsher drying rate within the kiln than the prescribed target drying rate when the drying rate of the charge of lumber does not exceed the maximum drying rate corresponding to each of the one or more time periods, and changing the kiln drying parameters to slow or reverse the drying of the charge of lumber when the drying rate of the charge of lumber over each of the one or more time periods exceeds the corresponding maximum drying rate. The one or more time periods and the corresponding maximum drying rates may be represented in one or more data tables in which the one or more time periods and corresponding maximum drying rates can be stored and from which the one or more time periods and associated maximum drying rates can be retrieved, for example.

Preferably, the one or more kiln drying parameters include prescribed kiln air circulation speed, the one or more monitored conditions include a case moisture content of the charge of lumber, the case moisture content being indicative of the moisture content at or near an outer part of at least one sample section of lumber of the charge, and the method further includes adjusting the operating speed of a fan promoting a drying airflow within the kiln to control the kiln air circulation speed and thereby control the case moisture content of the charge of lumber during drying. Preferably, the operating speed of the fan is adjusted when switching phases, for example.

Preferably, the one or more monitored conditions include the moisture content within the charge of lumber, and the moisture content within the charge of lumber includes a core moisture content and a case moisture content, the core moisture content being indicative of the moisture content at or near an inner part of at least one sample section of lumber of the charge and the case moisture content being indicative of the moisture content at or near an outer part of at least one sample section of lumber of the charge. The adjusting of the one or more kiln drying parameters may be in response to a change in the differential between the core moisture content and the case moisture content, and the adjusting of the one or more kiln drying parameters may promote a reduction in the differential between the core moisture content and the case moisture content, for example.

### GLOSSARY OF TERMS USED IN THE SPECIFICATION

### Kiln Types:

Conventional kiln: A kiln arranged to dry with heat generated substantially solely from means other than solar energy or radiation, such as heat generated by one or more gas or steam heating systems, for example.
Solar kiln: A kiln arranged to dry with heat generated substantially solely from solar energy or radiation.
Hybrid kiln: A kiln arranged to dry with either, or a combination of, heat generated from solar energy or radiation and heat generated from means other than solar energy and radiation, such as heat generated by one or more gas or steam heating systems, for example.

### Modes of Kiln Operation:

Solar mode (mode 1): A kiln operating mode in which the kiln operates to dry lumber with heat generated substantially solely from solar energy or radiation. Applicable to a solar or hybrid kiln.
Multi-mode (mode 2): A kiln operating mode in which the kiln may operate to dry lumber with heat generated substantially solely from solar energy (solar mode or mode 1 operation as defined above), or with heat generated substantially from means other than solar energy or radiation (heated mode or mode 3 operation as defined below), or with a combination of heat generated from solar energy or radiation and heat generated from means other than solar energy or radiation. Applicable to a hybrid kiln that may operate with or without supplementary heating systems engaged.
Heated mode (mode 3): A kiln operating mode in which the kiln operates to dry lumber with heat generated substantially solely from means other than solar energy or radiation, such as one or more gas or steam heating systems, for example. Applicable to a conventional kiln or a hybrid kiln.

Drying process: The entire drying process associated with drying a charge of lumber in a kiln from an initial state to a final target moisture content and condition.

Drying schedule: A series of tabulated data entries prescribing kiln drying parameters for various steps in the drying process. Advantageously, drying schedules, which prescribe the progression of kiln drying parameters throughout the drying process, are able to be viewed and adjusted by a kiln operator using an operator interface that may include a visual display and input units, for example.

Schedule steps: The periods between commencements of different kiln drying parameters prescribed by a drying schedule that typically correspond to different moisture content ranges the lumber passes through while drying. Typically the prescribed kiln drying parameters associated with each step become progressively harsher as the drying process progresses.

Fixed drying schedule: A previously proposed drying schedule that substantially prescribes pre-determined progressively more severe kiln drying parameters regardless of ambient or external environmental conditions or deliberately varied kiln drying parameters, with the duration of schedule steps usually determined to occur at predetermined decreasing levels of lumber mass.

Cycle: Typically, but not limited to, an approximate 24-hour solar cycle from sunrise to sunrise. Other cycle durations may be selected.

Cyclic drying: Term used to describe drying in which at least two different sets of kiln drying parameters may be applied to effectively accelerate, decelerate, substantially cease or even reverse drying during each cycle of the drying process.

Target drying rate: A target (or desired) drying rate expressed as a target moisture content loss of the lumber being dried per cycle.

Case: An outer, preferably outermost, surface or part of a sample piece or section of drying lumber; may refer to a depth of up to about 2 to 3 millimetres from the outermost surface, for example

Core: An inner, preferably innermost and/or central-most, part of a sample piece or section of drying lumber.

Differential moisture content: The difference between the moisture content measured at the case and the moisture content measured at the core (that is, case moisture content—core moisture content) expressed as a percentage of the core moisture content.

Phases: Periods of time within the steps of a drying schedule during which kiln conditions may be selected or varied to achieve desired conditions and outcomes. Phases advantageously establish kiln conditions appropriate to each mode of operation and dictate the level of lumber adsorption or absorption that may occur during the time that a phase condition is active. Types of phases may include, for example:
Drying phase (phase 1): A phase in which kiln drying parameters effecting drying conditions within the kiln that generally promote high levels of drying are prescribed; typically prescribed during daylight hours.
Equalisation phase (phase 2): A phase in which kiln drying parameters effecting drying conditions within the kiln that generally promote, in comparison to drying phase (phase 1), reduced drying levels and/or increased levels of moisture adsorption by the lumber. Typically prescribed when operating in multi-mode (mode 2) and engaging supplementary heating (such as a one or more gas, steam or electrical heating systems, for example), or when operating in heated mode (mode 3) at night or other times when solar heating is either inadequate or is not available.
Reconditioning phase (phase 3): A phase in which reconditioning kiln drying parameters that substantially either cease the net drying process or promote the reversal of drying by promoting moisture absorption by the charge are prescribed, thereby establishing conditions promoting redistribution of moisture within individual sections of the drying lumber to reduce drying stresses that may have accumulated. Typically prescribed at night when operating in solar mode (mode 1), or alternatively when operating in any of the three above modes and the target drying for a particular cycle has been achieved, for example.

### BRIEF DESCRIPTION OF THE DRAWINGS

Various embodiments of a method and system in accordance with the present invention will now be described, by way of example only, with reference to the accompanying drawings, in which:

FIG. 1 is a schematic of a system for drying a charge of lumber;

FIG. 2 is a schematic of a part of a drying schedule which is able to be viewed on a control screen of the system shown in FIG. 1;

FIG. 3 is a schematic flowchart of an example operation of the system shown in FIG. 1 over a cycle when the system is configured to operate the kiln in solar mode (mode 1);

FIG. 4 is a further schematic flowchart of an example operation of the system shown in FIG. 1 over a cycle when the system is configured to operate the kiln in heated mode (mode 3);

FIG. 5 is a further schematic flowchart of the operation of the system shown in FIG. 1 following the drying schedule shown in FIG. 2 to dry the charge; and

FIG. 6 is an example excess drying limits table for use by the system shown in FIG. 1.

### DETAILED DESCRIPTION

The present inventor has determined that it is highly advantageous to advance and retard the drying rate when drying lumber and to adjust kiln drying parameters during the drying process in response to changes in a range of conditions associated with the operation of the kiln. These conditions may include ambient or climatic conditions associated with the surrounding environment, conditions within kiln and properties of the drying lumber. For example, the kiln drying parameters advantageously may be cyclically adjusted in response to various monitored conditions to effect an increase in the drying rate during periods of relatively high ambient temperature and low ambient humidity, such as during daylight hours, and a decrease in the drying rate during periods of relatively low ambient temperature and high ambient humidity, such as at night.

The system and associated method in accordance with a form of the invention constantly modify kiln drying parameters by changing operating modes and/or phase conditions in response to changes in a number of monitored conditions. The system relies on measuring and monitoring key variable conditions, including the actual drying rate and moisture distribution conditions, which can cause drying stresses to accumulate in the drying lumber, compares these with schedule limits, and in response to changes in the monitored conditions adjusts kiln drying parameters in a controlled and preferably automated fashion to maintain desired drying performance in terms of both drying duration and quality of the dried lumber.

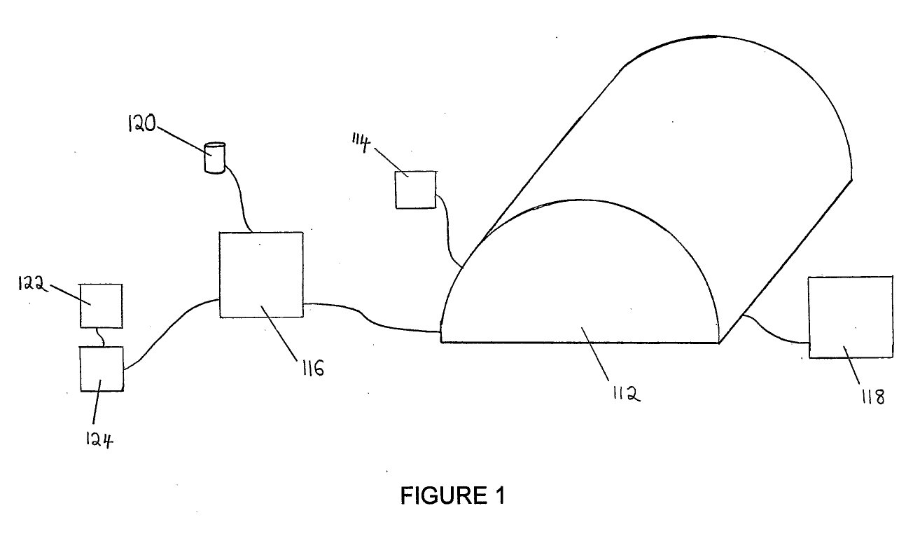

An example of a system 110 in accordance with the present invention is shown in FIG. 1. The system 110 includes a kiln 112, sensors 114 for sensing or monitoring a number of conditions associated with the operation of the kiln 112 when drying a charge of lumber (not shown) in a drying chamber of the kiln 112, and a control system 116 in the form of a computing system having an associated processing unit for controlling the operation of the kiln 112 and associated sensors 114. The kiln 112 is preferably a hybrid kiln, and in a particularly preferred form, is substantially as described in International Patent Application No. PCT/AU2005/001756, the full disclosure of which is incorporated herein by reference, additionally including an alternative or supplementary heating system 118, such as a gas, steam or electrical heating system.

The control system 116 advances and retards the drying rate of the charge of lumber by adjusting kiln drying parameters within each step and cycle during the drying process to control drying conditions within the chamber in response to changes in a range of monitored conditions of the ambient environment, conditions within the kiln 112 and lumber conditions. The control system 116, which is responsive to the sensors 114, relies on constantly sensing or measuring and monitoring key variable conditions that affect both the drying rate and the condition of the drying charge, and after comparing the actual conditions with allowable schedule limits, preferably automatically adjusts the kiln drying parameters at appropriate times to maintain desired drying performance and quality outcomes.

The conditions monitored, preferably continuously or substantially continuously, by the sensors 114 (not individually shown), may include the ambient temperature outside or surrounding the kiln 112, ambient absolute humidity or relative humidity (RH), ambient solar energy or radiation, ambient light intensity, ambient wind speed and ambient barometric pressure; the temperature within the drying chamber (kiln temperature) absolute humidity or RH within the drying chamber (kiln humidity), and circulation speed of the drying airflow within the drying chamber (kiln air circulation speed); the moisture content and distribution within the charge; the drying rate of the charge; and the duration of the drying process associated with drying the charge, for example. It will be understood that other conditions may also be monitored.

The sensors 114 advantageously include dual moisture content (MC) sensing systems for determining the MC of the drying charge, with separate electrical resistance type MC sensors for measuring the MC at the case and the core, and temperature-diffusion type MC sensors that rely on specie-relevant lumber or wood property temperature diffusion tables, wood temperature probes located in the kiln and real-time systemic calculations for measuring the MC at the core of the lumber. The temperature-diffusion type MC sensors may also be used for calibrating the electrical resistance type MC sensors. It will be understood that other types of sensors for determining the MC, preferably at both the core and the case, may alternatively be used as practical.

The electrical resistance type MC sensors, while having been found to be the more practical and accurate of the above two types of MC sensors for relatively low MCs, have been found to be limited in accuracy for MCs exceeding 35%, and accordingly the temperature-diffusion method is preferably used for measuring the core MC when the core MC is above 35%.

The core MC of the drying lumber may be used to determine when to advance to the next drying step as the drying process progresses, and the case MC (in combination with the core MC) may be used to determine when the case is drying too quickly relative to the core and therefore when to change the kiln drying parameters to equalise the MC throughout the lumber so as to prevent the accumulation of excessive drying stresses that can adversely affect the quality of the drying charge.

The control system 116 responds to changes in the monitored conditions as the lumber is drying to control the operation of the kiln 112 by adjusting a number of kiln drying parameters in a manner predetermined by the nature of the changes. The kiln drying parameters may include the prescribed temperature within the drying chamber (prescribed kiln temperature), prescribed absolute humidity or RH within the drying chamber (prescribed kiln humidity), prescribed over-temperature limit for the kiln 112 above which electrical components of the kiln 112 or the charge may be harmed (prescribed over-temperature limit), prescribed speed of the circulating drying airflow within the chamber (prescribed kiln air circulation speed), and prescribed target drying rate (TDR) of the charge. It will be understood that other kiln drying parameters associated with the operation of the kiln 112 may also be prescribed and controlled.

To facilitate the advancing and retarding of the drying rate, the system 110 also includes memory 120 for the storage and retrieval of data for the drying process, including multiple sets of drying schedules in the form of data tables having prescribed kiln drying parameters and limits for monitored conditions, relevant to each step of the drying process, and each mode of operation and each phase applicable to each step. The memory 120 is arranged for the storage and retrieval of the drying schedules and prescribed values by the control system 116.

The control system 116 also has a visual display unit in the form of a screen 122 for displaying to a kiln operator the monitored conditions, the predetermined changes or limits associated with the monitored conditions and prescribed kiln drying parameters, and an operator input unit 124 by which the kiln operator is able to manually adjust the limits and prescribed kiln drying parameters.

### Example Drying Schedule

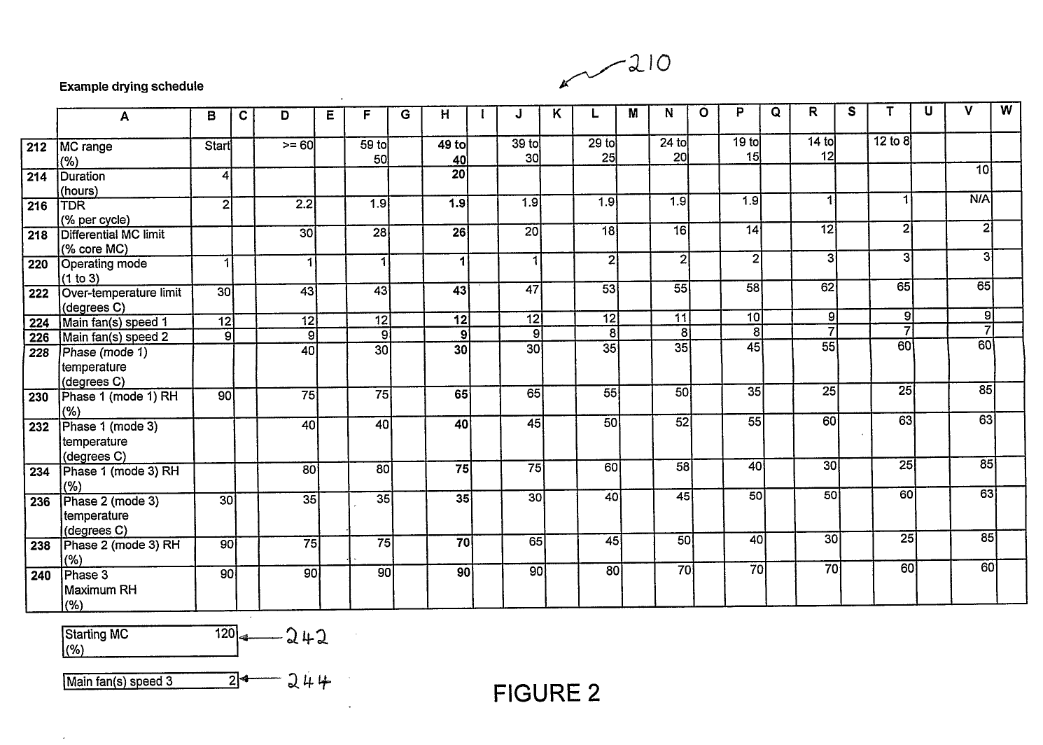

An example drying schedule 210 having prescribed ranges or limits for various monitored conditions and prescribed kiln drying parameters for use by the control system 116 when drying a charge of lumber (not shown) is shown in FIG. 2. The schedule 210 is advantageously displayed on the visual display unit 122 so that it is able to be viewed by a kiln operator, while the operator input unit 124 allows the operator to adjust the limits and kiln drying parameters. The schedule 210 may be specific to the specie of lumber being dried and kiln being used, and to the desired quality of the dried lumber. Further, while a single table is shown, advantageously in practice multiple schedules or tables may be selected from and/or used.

The schedule includes columns A to V, rows 212 to 240, and boxes 242, 244. Column A contains headings identifying each of the rows to the kiln operator, and columns B to V correspond to drying steps progressing from left to right with the drying of the charge during a drying process. Alternate columns B, D, F . . . contain predetermined values, ranges or limits for the monitored conditions and prescribed kiln drying parameters, and alternate blank columns (C, E, G . . . ) are for containing overriding entries that may be manually added by the kiln operator. The manual entries may be made in response to the results of manual tests, for example, or to deliberately vary properties of the dried lumber.

Row 212 contains a prescribed moisture range applicable to each step of the drying process. The moisture range corresponds to upper and lower MCs within the charge of lumber, as calculated at the core of a sample section or piece of the lumber, with the lower MC used by the control system 116 to determine when to progress to the next step. In the illustrated example, column B corresponds to the drying step at the starting MC, column D corresponds to the drying step when the core MC is not below 60%, column F corresponds to the drying step when the core MC is substantially in the range of 59 to 50%, and so on.

Row 214 contains an optional prescribed minimum duration for each step in hours. If a value is placed in this row by the kiln operator for a particular column (or drying step), the system 116 recognises that the transition to the next drying step is based on both the core MC (row 212) and duration (row 214) (or in alternative systems when there is no moisture sensing, on the duration (row 214) only). That is, the system 116 does not progress prescribed drying conditions to those prescribed in the next drying step until both the core MC within the charge of lumber has decreased below the range in row 212 and the present step has been active for at least the duration in row 214.

This entry (row 214) advantageously increases the flexibility of the system 110, and similarly the flexibility of alternative systems not having moisture sensing. For example, a kiln operator may use this entry to apply extreme fixed conditions for a short period of time to equalise the moisture content in the drying lumber after the target drying for a particular step has been achieved.

Row 216 contains a prescribed target drying rate (TDR) expressed as the percentage target MC loss (as measured at the core) per cycle. Each cycle corresponds to the approximately 24-hour solar cycle from sunrise to sunrise, however, it will be understood that each cycle could correspond to other time periods to suit specific species of lumber. For example, each 24-hour day may be broken up into multiple cycles.

Row 218 contains a prescribed maximum allowable differential between the core MC and the case MC of a sample section of lumber for a given step, expressed as a percentage of the core MC. The differential MC limit facilitates real time calculations by the control system 116 to determine when the drying rate of the case of the drying lumber needs to be retarded to prevent the accumulation of excessive drying stresses, as will be discussed below.

Row 220 contains a prescribed kiln operating mode at each step, in the instance of a hybrid kiln 112 being one of solar mode (mode 1), heated mode (mode 3), and multi-mode (mode 2) in which the kiln 112 is able to operate using either, or a combination of, solar heating and supplementary heating as required.

Row 222 contains a prescribed over-temperature limit for within the drying chamber within the kiln for each step. In solar mode (mode 1) or multi-mode (mode 2), the control system 116 governs the amount of heat generated by solar energy or radiation delivered into the drying chamber when the kiln 112 is operating above the prescribed kiln temperature so as to limit the temperature within the drying chamber to at or below the over-temperature limit, above which the drying charge may suffer degrade or electrical components of the kiln may be harmed.

Row 224 contains a prescribed setting (speed 1) for main fan(s) (not shown in FIG. 1) controlling the circulation speed of the drying airflow within the chamber when the drying phase (phase 1, see rows 228, 230 for example) conditions are being applied. A higher setting of 12 (at column H for example) corresponds to a higher air circulation speed in comparison to a lower setting of 9 (at column R for example) which corresponds to a lower air circulation speed, for example. Hotter air can typically be moved within the drying chamber more easily than cooler air. Accordingly, the operating speeds of any air circulation fans promoting the drying airflow within the chamber are advantageously reduced as the prescribed or actual operating temperature within the drying chamber increases so as to improve the electrical efficiency of the kiln.

Row 226 contains a prescribed setting (speed 2) for the main fan(s) for controlling the circulation speed of the drying airflow within the chamber, such as when equalisation phase (phase 2, see rows 236, 238 for example) conditions are being applied when the kiln is operating in multi-mode (mode 2) or heated mode (mode 3). The typically reduced speed of the main fan(s) when applying an equalisation phase, in comparison to a drying phase, slows the circulation speed of the drying airflow and the drying rate of the lumber, and advantageously facilitates the redistribution of moisture within the drying lumber, by reducing surface moisture evaporation rates.

Rows 228 and 230 contain a prescribed kiln temperature (degrees C.) and RH (%) for within the drying chamber when the control system 116 is operating the kiln 112 in solar mode (mode 1 in row 220) and applying drying phase (phase 1) conditions.

Rows 232 and 234 contain a prescribed kiln temperature and RH when the control system 116 is operating the kiln 112 in heated mode (mode 3 in row 220) and applying drying phase (phase 1) conditions.

Rows 236 and 238 contain a prescribed kiln temperature and RH when the control system 116 is operating the kiln 112 in heated mode (mode 3 in row 220) and applying equalisation phase (phase 2) conditions.

Row 240 contains a prescribed maximum RH (%) condition within the drying chamber of the kiln 112 when a reconditioning phase (phase 3) is prescribed.

Box 242 contains an initial starting core or case MC value for the charge being dried that may be input by the kiln operator, which may be an estimate relying on previous drying experience, or a value determined by an empirical test, such as an oven dry test, for example. The starting MC (box 242) may be used by temperature-diffusion type MC sensors, for example, that rely on a database storing historical dry rate data, and use the starting MC entry (120% MC at box 232 of the schedule 210) and the actual measurement from an integrated case measurement system to calculate the MC level. For determining the MC, the temperature-diffusion MC sensing system may include a number of temperature-diffusion tables and at least one lumber temperature sensor to estimate MC loss and to determine progressively decreasing MC levels in the lumber. Each temperature-diffusion table is specie dependent, and is typically a grid that defines how much moisture content (%) the wood or lumber will lose at a particular MC when drying at a particular temperature.

Box 244 contains a prescribed main fan setting (see rows 224, 226) when a reconditioning phase (or phase 3) is prescribed within the drying chamber, as may occur in response to the target drying being achieved for a particular cycle, or at night when operating in solar mode (mode 1), for example.

It will be understood that the values shown in FIG. 2 can be manually adjusted by the kiln operator at the start of the drying process or as the drying process progresses by manually making overriding entries in any of alternate columns C, E, G . . . , and that the values shown in the drying schedule 210, which have been provided as a non-limiting example only, may vary significantly with the specie being dried, required properties of the dried charge and/or properties of the kiln and surrounding climate, for example. Advantageously a plurality of different drying schedules are provided for use by the system 116 when drying different species with different desired qualities of the dried lumber.

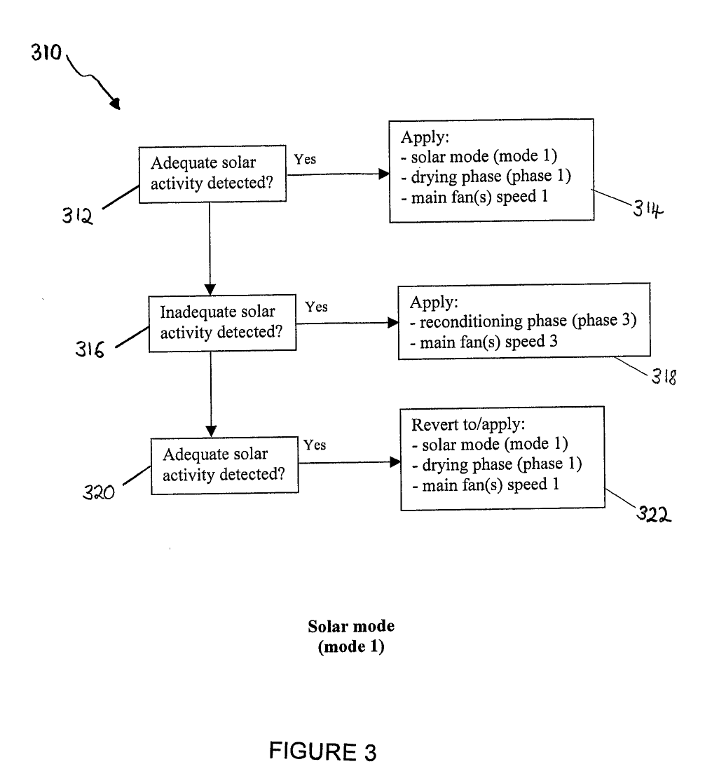

The system 110 may operate to dry lumber in solar mode (mode 1), heated mode (mode 3), or multi-mode (mode 2) in which the operation of the kiln 112 is able to switch between drying with solar energy (effectively solar mode), or with supplementary heating (effectively heated mode), or with a combination of solar energy and supplementary heating. Examples of a basic operation of the system 110 to dry a charge of lumber over an example cycle exclusively in either solar mode (mode 1) or heated mode (mode 3) will now both be generally described with reference to FIGS. 3 (solar mode) and 4 (heated mode).

FIG. 3 shows a flowchart 310 illustrating a basic example operation of the kiln 112 in solar mode (mode 1 in row 220). Commencing a cycle, an ambient light intensity sensor detects adequate solar activity (reference numeral 312), such as at sunrise for example, at which time the control system 116 responds (reference numeral 314) by adjusting the prescribed kiln drying parameters by switching to a drying phase (phase 1 in rows 228 and 230) promoting high levels of drying and adjusting the speed setting for the main fans controlling the air circulation speed within the drying chamber of speed 1 (row 224). Alternatively, the application of the drying phase may be triggered by a sensor detecting solar or ultra-violet radiation intensity, for example.

The control system 116 continues to apply the drying phase until the ambient light intensity sensor detects inadequate solar activity (reference numeral 316), such as at sunset or night for example, at which time the control system 116 may respond (reference numeral 318) by adjusting the prescribed kiln drying parameters by switching the phase applied within the chamber to a reconditioning phase (phase 3, row 240) and the speed of the main fan(s) to speed 3 (box 244). The reconditioning phase advantageously establishes conditions promoting redistribution of moisture within individual lumber sections to reduce stress.

When the kiln 112 is operating exclusively in the solar mode (mode 1) and the temperature within the drying chamber cannot or is not desired to be increased or controlled during times of inadequate solar activity by way of supplementary heating (as may occur in either of multi-mode and heated mode), the control system 116 may operate the kiln 112 with a prescribed reconditioning phase (phase 3) having an associated maximum RH setting (row 240), without a prescribed temperature setting as with the drying and equalisation phases (phases 1 and 2). In the reconditioning phase, the control system 116 advantageously negates water misting and allows heat to be retained by operating main circulation fans slowly (speed 3 in box 244) and limits the occurrence of venting to only when air re-saturates to above a prescribed high RH limit (row 240) at which electrical components of the kiln could be potentially harmed.

When the ambient light sensor again detects adequate solar activity, such as at sunrise at the start of the next cycle (reference numeral 320), the control system 116 may respond (reference numeral 322) by reverting to applying the drying phase (phase 1, rows 230, 232) in solar mode (mode 1) and operating the main fan(s) at speed 1 (row 224) conditions.

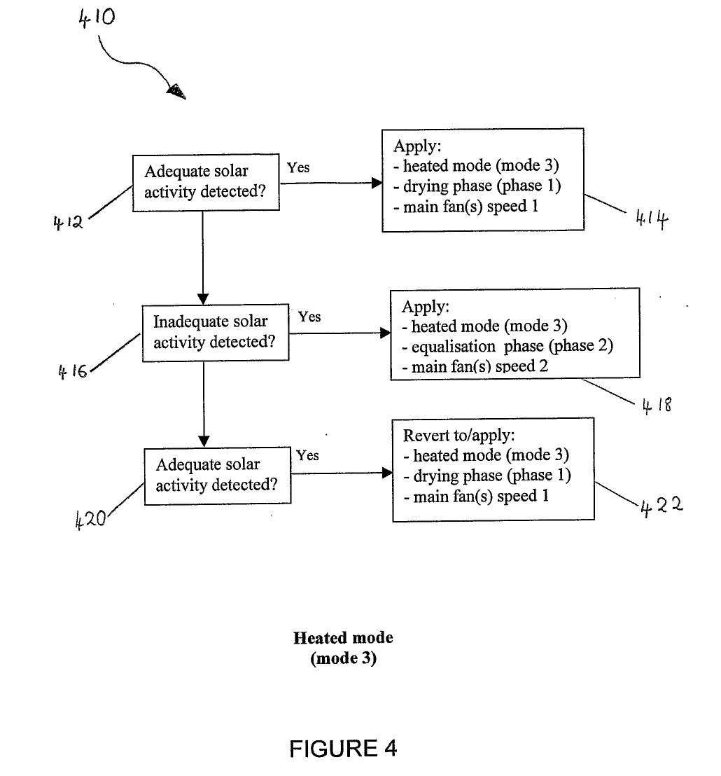

Similarly, with reference to the example flowchart 410 shown in FIG. 4, when the kiln 112 is operating exclusively in heated mode (mode 3 in row 220), when the ambient light intensity sensor of the control system 116 detects adequate solar activity at the beginning of a cycle (reference numeral 412), such as at sunrise for example, the control system 116 may respond (reference numeral 414) at that time by adjusting the prescribed kiln drying parameters by switching the phase applied within the chamber to a drying phase (phase 1, rows 228, 230) and the speed of the main fan(s) to speed 1 (row 224), for example. The control system 16 continues to apply the drying phase (phase 1) until the ambient light intensity sensor detects inadequate solar activity or sunset (reference numeral 416), at which time the control system 116 may respond (reference numeral 418) by adjusting the prescribed kiln drying parameters by switching the phase applied within the chamber to an equalisation phase (phase 2 in rows 236 and 238) and adjusting the speed of the main fan(s) to speed 2 (row 226). The prescribed equalisation phase advantageously reduces drying levels and increases the level of moisture adsorption by the lumber, in comparison to the drying phase. When the ambient light sensor again detects adequate solar activity, such as at the start of the next cycle (reference numeral 420), the control system 116 may respond (reference numeral 420) by reverting to applying the drying phase (phase 1, rows 232 and 234) and main fan speed 1 (row 224) conditions.

### Example Drying Process

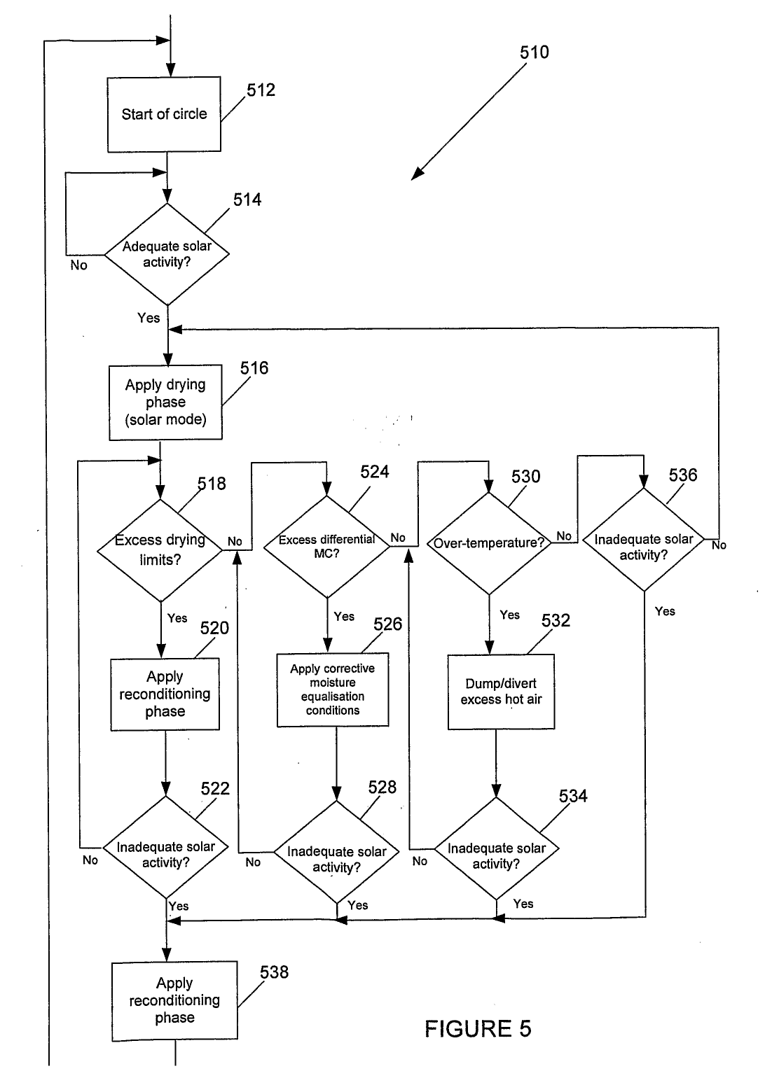

A further example operation of the control system 116 when operating a hybrid kiln 112 which illustrates how the control system 116 uses predetermined values, ranges and limits for monitored conditions and prescribed kiln drying parameters of the drying schedule 210 to control drying by changing the applied phases in response to changes in the monitored conditions will now be described with reference to the flow chart 510 shown in FIG. 5.

The example operation of the control system 116 will be described predominantly with reference to column H of the schedule 210 (corresponding to the step for which the core MC of the drying lumber is within the range of 49 to 40%) with the control system 116 configured to operate the kiln 112 in solar mode (mode 1 in row 220). While in column. H, the kiln 112 is configured to operate in solar mode (mode 1), it will be understood the kiln 112 may be configured to operate in multi-mode (mode 2) or heated mode (mode 3), depending on the entry in row 220. Selectively or automatically switching to multi-mode or heated mode using the entry in row 220 may be useful in certain situations, for example, where it might be practical to add a controlled heat period as an extra method of moisture equalisation. Advantageously, the system 116 allows an operator to pre-program automatic changes for mode and prescribed kiln drying parameters at any stage of the drying process.

Further, switching between modes facilitates efficient energy management and optimisation of the drying rate. If for example, the system 116 recognises that TDR rate has not been achieved for the past cycle and a barometric sensor detects pressure is falling, it may be practical to automatically change the operation of the kiln 112 from solar mode (mode 1) to multi-mode (mode 2) or heated mode (mode 3) until the barometric pressure rises to a point where solar heating is capable of producing the required drying rate. Conversely, if the barometric pressure is found to be rising, it may be possible to use a logged history of previous weather and drying processes to assist in determining when to change from multi-mode (mode 2) or heated mode (mode 3) to solar mode (mode 1).

### Step Transition

During the drying process, the core MC of the drying lumber is advantageously determined on a continual basis (not shown) and is used to control the timing of the transition to the next drying step (or column in the schedule 210) as the drying process progresses. The MC range applicable to each drying step is shown in row 212 of the example drying schedule 210. As the process reaches each of the various ranges for core MC as contained in row 212, subject to there being no time-based criteria at row 214, the control system 116 advances left to right through the steps (corresponding to the columns of the schedule 210), with each step typically prescribing increasingly severe drying conditions as the process progresses.

Continually measuring the core MC enables the control system 116 to continually determine the drying rate of the charge and react when it is either too great or too small relative to the prescribed TDR (row 216). For example, if the control system 116 were alternatively operating the kiln 112 in multi-mode (or mode 2) and the actual drying rate was found to be inadequate to maintain the prescribed TDR, the control system 116 may operate the kiln 112 to the dry the lumber simultaneously with the combination of both heat generated from solar energy and supplementary heaters, such as by using steam, gas or electrical heating systems 118 to supplement the solar heating, for example. When operating in solar or multi-modes, the control system 116 may also react to a slow actual drying rate by altering phase conditions to avoid heat loss from the core of the lumber.

### Commencing Drying Phase

With reference to FIG. 5, at the start of each solar cycle (reference numeral 512), an ambient light sensor detects solar activity (reference numeral 514). When sufficient or adequate solar activity to indicate the onset of daylight or sunrise is detected, subject to a range of monitored conditions not exceeding defined limits as will be discussed below, the control system 116 commences to operate the kiln 112 in solar mode (mode 1) and applies a drying phase (phase 1) (reference numeral 516) within the chamber, wherein the prescribed kiln temperature is 30 degrees C. (column H, row 228), the prescribed RH is 65% (row 230), and the speed of the main fan(s) is set to speed 1 (setting 12 from column H, row 224).

### Excess Drying Limits

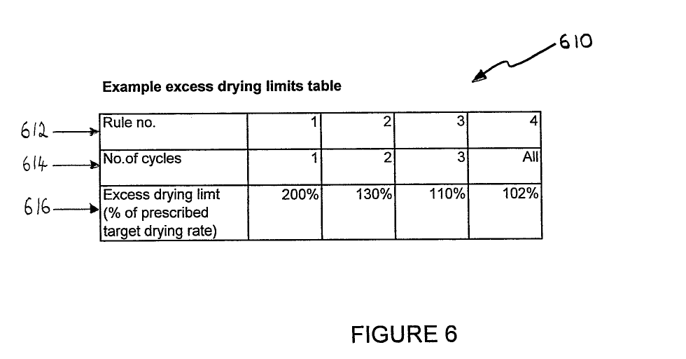

While the drying phase conditions are being applied within the chamber (reference numeral 516), the control system 116 advantageously allows the lumber to dry at an actual drying rate higher than the prescribed TDR for periods of time, subject to predetermined excess drying limits not being exceeded (reference numeral 520). If these excess drying limits are exceeded, the control system 116 recognises that the lumber may potentially be drying dangerously fast, to the detriment of the quality of the dried lumber, and responds by applying a reconditioning phase (phase 3), during which time other MC related responses such as differential MC limits (discussed below) are idle such that they effectively cease. The check to determine whether excess drying limits have been exceeded at reference numeral 518 may be performed using an excess limits table 610 (shown in FIG. 6), as will be described below.

The first row 612 of the table 610 contains numerals 1 to 4, which serve to identify rules to be checked and the associated left to right (as viewed) sequence in which the rules are checked. The second row 614 contains the number of cycles (current plus immediately previously completed cycle(s)) relevant to each rule. The third row 616 contains a prescribed excess (or maximum) drying limit, which is expressed as a percentage of the prescribed TDR (row 3) relevant to each rule. The table 610 advantageously allows the control system 116 to effect higher levels of control to provide for the safe drying at accelerated rates, particularly for when drying species and products that are particularly sensitive in quality terms at accelerated drying rates, as will be discussed below. All entries in the second and third rows 614, 616 advantageously may be varied by the operator, and may be dependent on a range of factors including the specie being dried, characteristics of the kiln 112, the mode of operation, the phase conditions being applied and the particular drying step, for example.

### Example Calculation of Excess Drying Limits

The use of the table 610 to calculate excess drying limits for the control of accelerated drying rates will now be described by way of the following non-limiting example.

Excess drying limits are preferably checked substantially constantly at all times when applying drying phase (phase 1) (or alternatively equalisation phase (phase 2)) conditions within the chamber. For performing the associated below calculations, the control system 116 includes a counter (not shown) that records the number of completed cycles and logs all previous drying history. Further, in the example, all actual MC losses are determined from the core MC.

The control system 116 first considers rule 1 for the current cycle (that is, one cycle in row 614 of table 610). From row 216 (column H) of the drying schedule 210 shown in FIG. 2, the current prescribed TDR is 1.9% per cycle. From row 616 of the table 610, the excess drying limit for rule 1 is 200% of the TDR. The excess drying limit of this rule is calculated as 1.9% X 200%, or 3.8% MC loss. Therefore, the actual drying for the current cycle is allowed to exceed the target drying of 1.9% MC loss, subject to both the actual drying not exceeding the 3.8% excess drying limit and remaining rules 2 to 4, where applicable, being followed. That is, subject to rules 2 to 4, the drying phase (or alternatively, possibly an equalisation phase if operating in heated mode) may only continue until a total 3.8% MC loss has been reached for the current cycle.

The control system 116 next checks rule 2 for the current and immediately previously completed cycle (that is, two cycles in row 614). As above, the current TDR is 1.9% per cycle and from row 616 the excess drying limit for rule 2 is 130% MC loss for the two cycles. Therefore, the actual drying for the two cycles is allowed to exceed the target drying of 3.6% MC loss (1.9% X 2 cycles), subject to the actual drying not exceeding the 4.9% excess drying limit (1.9%×130%×2 cycles) of rule 2 and the remaining rules 3 and 4, where applicable, being followed. Therefore, if the actual drying of the previous cycle was the maximum allowable 3.8% for a single cycle (rule 1 above), then, subject to rule 3 and 4, the drying phase (or alternatively, possibly equalisation phase if operating in heated mode) may only continue until a total 4.9% MC loss has been reached for the collective two cycles; that is, when a further 1.1% (4.9%-3.8%) MC loss has been achieved in the current cycle.

The control system 116 next checks rule 3 for the current and immediately previously completed two cycles (that is, three cycles in row 614) and is only applicable if the drying process has advanced to at least a third cycle. As above, the current TDR is 1.9% per cycle and from row 616 the excess drying limit for rule 3 is 110%. Therefore, the actual drying for the three cycles is allowed to exceed the target drying 5.7% MC loss (1.9%×3 cycles), subject to the actual drying rate not exceeding the 6.3% excess drying limit (1.9%×110%×3 cycles) of rule 3 and remaining rule 4, where applicable, being followed. Therefore, if the actual drying for the immediately two previously completed cycles was 4% moisture loss, for example, then, subject to rule 4, the current drying phase may only continue until a further 2.3% MC loss (6.3%-4%) has been achieved in the current cycle.

The control system 116 lastly checks rule 4 for the current and all previously completed cycles (row 614), and is only applicable if the drying process has advanced to at least a fourth cycle. As above, the current target drying rate is 1.9% and from row 616 the excess drying limit for rule 4 is 102%. Therefore, if the drying process is in its 14th cycle, for example, then the actual drying over the duration of the drying process is allowed to exceed the target drying 26.6% (1.9%×14 cycles), subject to the actual drying rate not exceeding the 27% excess drying limit (1.9%×102%×14 cycles) of rule 4.

Returning to FIG. 5, if any of the excess limits have been exceeded (reference numeral 518), the control system 116 may respond by applying reconditioning phase conditions (reference numeral 520), wherein a maximum RH is set at 80% (row 240), for example, and the main fan(s) are set to operate at fan speed 3 (setting 2 in box 244 at column H). The application of the reconditioning phase preferably results in drying conditions within the drying chamber that effectively limit the drying rate to a minimum or, depending on the settings, optionally reverse the drying process by re-saturating the lumber. While applying reconditioning phase (phase 3) conditions, the ambient light sensor continues to check solar activity or ambient light (reference numeral 522). While adequate solar activity is detected, the control system 116 continues to apply the reconditioning phase conditions (reference numeral 518) until the excess drying rate has ceased, at which time, in the example flowchart 510, the control system 116 will revert to applying the drying phase (phase 1) while operating the kiln in the solar mode (mode 1 in row 220) (reference numeral 514).

It will be understood that rules associated with the excess limits table are applied sequentially, and that each rule only becomes applicable if the excess drying limits of previous rules (where applicable) have not been exceeded and the minimum required number of completed cycles for the particular rule to be applicable have transpired. Otherwise, if rule 4 were to be applied from day 1, for example, the other rules would be redundant.

Further, the number of rules (row 612), cycles applicable to each rule (row 614) and the predetermined excess drying limits (row 616) may all be varied to suit requirements.

If the applicable cycle(s) when determining the excess drying limit for any of the above rules spans two or more different steps, and in consequence involve two different TDRs, the TDR for the current step may be used for calculating the excess drying limits (as it has been in the above examples), although it will be understood that alternatively the TDRs of each step may be used when calculating a respective portion of the combined excess drying limit, for example.

### Differential MC Limits

To facilitate accelerated drying when conditions are favourable for drying at times of high solar activity during the daytime, without detracting from the quality of the dried lumber, the control system 116 also checks the differential MC between the case and the core of the drying charge (reference numeral 524). By controlling the case-core differential MC during periods of accelerated drying, the surface of the lumber may be allowed to dry both quickly and safely, such as at times of high solar activity during the daytime for example, towards a target defined by the system 110 using schedule entries and the moisture detection systems. By maintaining case-core differential MCs preferably substantially at or close to predetermined limits, advantageously excessive drying stresses are prevented from accumulating in the drying charge when drying at advanced rates, while at the same time the mechanical diffusion (or drying) rate is optimised. Moreover, at night, the cooler reconditioning phase in solar mode (or optionally equalisation phase if alternatively operating in multi-mode or heated mode), is also able to relieve any stresses and reduce case-core differential MC in the lumber that may have accumulated during accelerated drying in daylight hours.

### Example Calculations of Differential MC Limits

At row 218 of the schedule 210 (column H), a differential MC limit of 26% of the core MC is prescribed. If a core MC of the charge is found to be 45% by a first MC sensor located at or near a core of the drying charge and the case MC is found to be 35% by a second MC sensor located at or near a case of the drying charge, for example, the difference is 10%. This corresponds to an actual differential MC of 22% (corresponding to the difference between the core MC and the case MC of 10% expressed as a percentage of the core MC of 45%). As this is lower than the prescribed differential MC limit of 26% (row 218), the control system recognises that it is safe to continue in solar mode (mode 1) applying default drying phase, (phase 1) conditions.

When harsh drying conditions finally achieve the operator's aim to quickly dry the case such that mechanical diffusion is at its optimal level, once the prescribed differential MC limit of 26% is reached, the control system 116 applies corrective moisture equalisation conditions (reference numeral 524) so as not to exceed the prescribed limit (row 218). By optimal level, it is meant when the case MC has reached a point where it is as dry as it may be (relative to the more slowly drying and shrinking core) such that adsorption is at its peak (lowest) level but stress that has accumulated in the drying lumber has not exceeded the predetermined danger point (26% differential MC for the step of the drying process in column H, for example).

When the core MC level is found to be 45%, for example, the prescribed differential MC limit of 26% (row 218, column H) corresponds to a differential between the core and case MCs of 11.7% (26% of 45%). Therefore, the case MC level at this stage of the drying process may be as low as about 32.3% (45% case −11.7% difference) before the control system 116 recognises that it needs to take corrective action by prescribing a humidity condition within the kiln 112 that maintains the current case MC level (or the differential MC level) to at or below this level.

The automated responses by the control system 116 when applying corrective moisture equalisation conditions (reference numeral 528) may include (response 1) finding (from one or more psychometric tables, for example) and applying higher humidity conditions within the drying chamber by overriding normal venting activity or by spraying water into the drying chamber, for example. Preferably, the prescribed humidity condition within the drying chamber may be increased by prescribing a substantially same equilibrium moisture content (EMC), higher humidity condition within the chamber. Applying moisture equalisation conditions may also include (response 2) applying slower main fan(s) speed conditions to reduce surface evaporation and hence case moisture loss to control the situation. For example, if response 1 fails to achieve its objective after a set time, then response 2 might be effected by changing from row 224 main circulation fan(s) speed 1 to the slower row 226 main circulation fan(s) speed 2. When case moisture levels reach required levels, the above sequence of response 1 and then response 2 may reversed by first (reversing response 2) changing the speed of the main fan(s) back to speed 1 prior to (reversing response 1) applying the previously prescribed drying condition, and more particularly lower RH condition, within the drying chamber.

Because the differential MC is expressed as a percentage of the core MC, the control system 116 uniquely maintains a preferably constantly revised new, safely defined differential MC as the core MC decreases. The novel control of drying conditions and associated data tables that facilitate this control allow the desired wood lumber condition to be reached quickly and effectively so that diffusion is accelerated until the case condition reaches critical limits where it is recognised excessive stresses may accumulate in the charge. Without the preferably continuous monitoring of the differential MC the outer case may dry at dangerously higher levels relative to the core of the lumber during times of advanced drying that can be detrimental to the quality of the dried lumber.

Returning to FIG. 5, while the differential MC exceeds the prescribed differential MC limit (reference numeral 524), the control system may continue to apply moisture equalisation conditions (reference numeral 526) while adequate solar activity is detected (reference numeral 528) and until the differential MC is again preferably substantially at, or below, the prescribed differential MC limit (reference numeral 524).

### Over-Temperature Limit

Advantageously, during the drying process, the control system further limits the temperature within the kiln 112 below a prescribed over-temperature limit (row 222) for each step of the drying process (reference numeral 530). The over-temperature limit is not less than the current prescribed kiln temperature (rows 228, 232 or 236 for example), and allows the temperature within the drying chamber to exceed the prescribed kiln temperature when solar energy is surplus to the requirements of the prescribed temperature, without adversely affecting the quality of, or degrading, the drying charge or harming electrical components of the kiln 112. When the temperature within the kiln (112) exceeds the prescribed over-temperature limit, the control system may respond by dumping and diverting excess hot air (reference numeral 532) that has been heated by solar energy until the kiln temperature returns to below the prescribed over-temperature limit (row 222).

The over-temperature limit facilitates the drying of the charge at a preferably advanced drying rate (above the prescribed TDR) in favourable drying conditions and the absorption and storage of surplus energy by the charge to avoid waste at the same time as reducing supplementary heat energy requirements at night. For example, in column H, the prescribed kiln temperature may be set at 30 degrees C. (solar mode, drying phase or phase 1 in rows 228, 230) and the over-temperature limit may be set at 43 degrees C. (row 222). If solar energy is available to exceed the prescribed temperature limit, the control system 116 may allow solar heat to enter and be retained inside the kiln until the active 43 degrees C. limit is reached. By allowing the lumber to substantially absorb and store surplus solar energy during the daytime, if the control system 116 switches the operation of the kiln 112 to multi-mode or heated mode at night, heaters will typically not resume operation until later at night than otherwise would be the case if the temperature within the drying chamber had been limited to 30 degrees C.

Alternatively, if the kiln is operating in multi-mode with a supplementary heating system 118 engaged, the supplementary heating system 118 may be used to heat the drying chamber to the prescribed temperature, and solar heat, as available, may be allowed to enter the kiln and boost temperature levels (and the drying rate) within the drying chamber until the temperature reaches the over-temperature limit.

Advantageously, it has been found that the over-temperature limit is able to be adjusted during the drying process based on a range of factors, including whether or not supplementary heating systems 118 are engaged when operating in multi-mode or heated mode, the specie of lumber being dried and the stage of the drying process. For example, the sensitivity of lumber quality degrade due to higher operating temperatures within the chamber decreases as the process progresses. Accordingly, as the drying process progresses, according to a form of the present invention, the over-temperature limit may advantageously be set progressively higher.

By automatically adjusting, preferably maximising, the over-temperature limit over the duration of the drying cycle and applying an advanced or faster drying rate during daylight hours and a milder or slower drying rate at night, more solar heat is able to be delivered to within the chamber before excess air that is heated by solar radiation needs to be diverted or dumped from the kiln to the external environment. This cyclical adjustment of the over-temperature limit may be based on stored or logged data, independent of manual adjustment by kiln operators, and in effect allows otherwise wasted heat energy from solar radiation to be absorbed by and accumulated in the lumber mass, providing a bank of available heat energy for use at night instead of costly supplementary heat energy. It is contemplated that in many locations, several hours of heater operation may be saved, or preferably heater operation may be avoided completely, drying time reduced and considerable energy consumption avoided using a form of the present invention incorporating an over-temperature limit at each step of the drying process.

### Night

Subject to the above checks (reference numerals 518, 524 and 530), the control system continues to apply drying phase (phase 1) conditions in the solar mode (mode 1), or alternatively other phase conditions if operating in multi-mode (mode 2) or in heated mode (mode 3), or any of the responses outlined at reference numerals 520, 526, 532 until inadequate solar activity, such as at night or sunset in the example flowchart 510, is detected (reference numerals 522, 528, 534, 536). The control system 116 may then apply a reconditioning phase (reference numeral 538) over night. Alternatively (not shown), if operating in multi-mode (mode 2) or heated mode (mode 3) the control system 116 may apply equalisation phase (phase 2) conditions over night. The control system 116 will continue to apply the reconditioning phase (or optionally equalisation phase if operating in multi-mode or heated mode) until adequate solar activity or sunrise is detected at the start of the next cycle (reference numerals 510, 512).

### Completion of the Drying Process

The drying process continues sequentially progressing through the drying steps, until the final MC of 8% (column V) is achieved. In the final step shown in column V, the dried charge of lumber is effectively maintained at that MC of about 8% for 10 hours to relieve any residual drying stresses that may have built up in the lumber over the drying process and to promote the equalisation and even distribution of remaining moisture of individual boards of lumber forming the charge.

It will be understood that the schedule 210 shown in FIG. 2 and the flowchart 510 shown in FIG. 5 are only one example of how a system in accordance with the present invention is able to operate and control the safe drying of a charge of lumber when cyclically adjusting kiln parameters. For example, the prescribed limits and drying parameters particular to each phase or mode may be stored in more than one drying schedule or data table. When operating in multi-mode (mode 2), separate schedules and table entries advantageously allow the control system 116 to change mode and kiln conditions in a fully controlled and automated manner, where each set of operational condition settings reflect the preferably constant delivery of heat energy under separate modes of operation. The control system 116 may be configured to operate the kiln 112 according to a first drying schedule for daylight hours and according to a second drying schedule at night, for example, so as to allow the kiln 112 to operate with a relatively high operating temperature within the chamber during the day and a lower operating temperature within the chamber at night.

It will be understood, in the instance of a conventional kiln for example, the system may alternatively be configured to operate with reduced complexity by switching between different phases in response to a detected difference between the temperature as measured at the core of the charge and the temperature as measured at the case of the charge, and/or the differential MC as determined by any suitable method. The detected temperature may be used to determine the core MC, and ultimately the differential MC, for example.

Further, it will be understood that the changes effected by the control system 116 may be manually effected by a kiln operator.

While only three phases have been described above, it will be understood that there may be any number of phases applicable to each mode and/or step of the drying process. In the instance of a solar or hybrid kiln, preferably the phases include at least a phase appropriate to typical diurnal conditions where the drying rate may be advanced, such as a drying phase for example, and a phase appropriate to typical nocturnal conditions where the drying rate may be retarded, such as an equalisation or reconditioning phase, for example. Further, each phase may correspond to a substantially different EMC condition to be applied within the drying chamber. Still further, while a preferred form of the present invention has been described predominantly with reference to solar and hybrid kilns, it will be understood that phase conditions may be cyclically adjusted and the excess drying limits (reference numeral 518), excess differential MC checks (reference numeral 524) and over-temperature limit (530) may be similarly applied to both control and maximise drying rates and quality of the dried lumber when drying in a conventional kiln.

Further, while the three checks at reference numerals 518, 524, 530 have been described when combined to control the drying a charge of lumber, it will be understood they each may be effected independently of one another. The system of checks (reference numerals 518, 524 and 530) preferably continues for the duration the process such that the control system 116 actually determines when the safe drying rate has been reached and in consequence drying phase (phase 1) conditions need to be changed, such as by switching to reconditioning phase (phase 3) conditions that retain kiln heat, promote reduced drying and equalise moisture distribution within the drying lumber being dried. Phase conditions may be cyclically adjusted with each cycle and step of the drying process. In some instances, depending on the species and product being dried, phase changes may be programmed to take place as many as 0 to 60 (and even more) times during each step, for example. Changes due to monitoring of excess drying limits (table 610) may occur substantially constantly, for example.

As each new step comes into effect, or during each step, a new mode may be automatically and optionally adopted, as specified within the drying schedule entry at row 220. For example, in a hybrid kiln 112 having both solar drying capacity and supplementary heating systems 118, the control system 116 may be configured to automatically change the operating mode in some circumstances within individual steps. Alternatively, the operating mode may be manually adjusted by a kiln operator in some circumstances within individual steps

Further, the described drying process may alternatively optionally be split into a plurality of distinctly different or optionally same condition cycles, each typically assigned to, but not limited to appropriate parts of an approximate 24-hour solar cycle from sunrise to sunrise.

Further, while the switching between different phases has been described predominantly with reference to substantially applying a drying phase where appropriate during the daylight component of a 24-solar day or cycle, it will be understood that the system 116 may be configured to switch between different phases at substantially any point within a cycle and the drying process, including at night. For example, it may be desirable using an alternative drying schedule to apply one or more drying phases at night using a supplementary heating system, such as a steam boiler for example, and then to apply one or more equalisation or reconditioning phases during daylight hours, so as to best manage energy flow from the boiler. Alternatively, the kiln may be configured to apply a drying phase at night by utilising off-peak electricity or hot water.

The various features of the system 110, including switching the operating mode and/or the phase conditions in response to a number of monitored conditions, excess drying limits, differential MC limits and over-temperature limits, may be variously combined to provide a flexible system and associated method suitable for application to all types of kilns when drying lumber. The system 112 and associated method advantageously allow drying to be safely concentrated into daylight hours and controlled so that solar heat, where applicable, may be used when it is available, reducing requirements for heat storage devices and losses associated with the required heat exchange process. Further, advantageously drying and venting heat losses associated with humidity control venting and air re-heating may be concentrated during daylight hours (in-lieu of night) when air conditions are warmer and re-heating of air is less costly in energy terms, and insulation losses at night are minimised by a strategy and control system that reduces kiln operating temperatures when ambient air is coldest. Further, the system 110 and associated method advantageously may reduce net heat energy consumption while achieving the same drying rate; for example, the present inventor has found that the same level of drying of lumber in a kiln can be achieved in a kiln in about 10 hours by operating at temperatures as little as 2.5 degrees C. above the level required to achieve the same drying in 24 hours when operating with substantially constant conditions. As such, it is contemplated that cyclic drying in the form described above may result in faster drying results than conventional fixed schedule drying with improved quality outcomes and reduced energy input.

By switching modes of operation in response to changes in the monitored conditions, the control system 116 may maintain target or minimum drying rates in adverse conditions. For example, when the kiln 112 is set to operate in solar mode (mode 1) to reduce energy consumption during daylight hours and the drying rate falls below required limits because of poor weather conditions, the control system 116 may monitor, detect and correct this situation by automatically changing to heated mode (mode 3) operation. Dual, separate schedules 210 appropriate to each mode of operation, may be used to apply conditions that are suitable for and appropriate to the differing modes of operation. For example, the severity of allowable kiln temperatures and kiln humidity conditions within the drying chamber will typically be set at higher levels for solar mode than heated mode, reflecting the fact that peak conditions in solar mode are only likely to be applied for a shorter time than when supplementary heating systems 118 are engaged in multi-mode or heated mode provide constant conditions; if the broad control limits that are typically applied to solar mode operation were applied to constant conditions facilitated by heated mode (mode 3) then excess drying and degrade would occur. The flexibility of being able to switch modes also provides the flexibility to automatically regulate and/or concentrate drying to specific phases within any cycle.

By adjusting or varying phase conditions in response to changes in the monitored conditions, subject to schedule settings applied, the control system 116 is able to optionally concentrate drying activity to daylight hours. Adjusting or varying phase conditions also provides a mechanism for alternative kiln conditions to be imposed to facilitate and regulate drying rate performance outcomes. For example, when drying phase (phase 1) conditions achieve the schedule-defined/prescribed target drying, milder phase conditions may be automatically applied to reduce, cease or reverse the lumber drying rate until the beginning of the next cycle. Varying phase conditions also provides a method of applying regulated lumber heating and cooling that reduces differential MCs between the core and the case, provides beneficial stress relief during each cycle and significantly improves quality outcomes in a controlled and predictable manner.

Advantageously, the multiple fan speed entries (rows 224,226 and box 244 for example) within each schedule for controlling the circulation speed of the drying airflow facilitate the control of the drying rate, particularly at the case, and surface evaporation requirements appropriate to the phase condition being applied. The multiple fan speed entries advantageously provide the capacity to slow and speed up fan speeds as a way of controlling case moisture loss and drying stress levels when differential MC limits are reached and surplus heat energy is available, so as to ultimately control the quality of the dried lumber. Further, the slower circulation fan speed settings may be applied to reduce electrical energy consumption when temperature is lower at night and when drying rate is reduced or reversed.

Further, by measuring both core MC and case MC of the drying lumber, it is possible for the control system to impose regulatory systems including calculated EMC conditions that maintain case moisture levels at safe levels only when the need arises. In practise, it has been found, subject to schedule parameters, that case moisture levels may optionally be increased during reconditioning phase (phase 3) conditions and drying stresses relieved such that critical stress limits may not actually be reached until some considerable time has elapsed after drying phase (phase 1) conditions are cyclically applied at the start of the following cycle. Not applying a balancing phase or EMC condition as a matter of course avoids wasting considerable amounts of energy and reducing the drying rate, until such time as it is actually necessary to do so.

It will be understood that the various configurations as described herein with reference to particular examples of the present invention may be employed in combination, even though they may not have been specifically described or shown in such a combination. Further, modifications and enhancements of the above-described examples may be apparent to those skilled in the art, without departing from the spirit and scope of the present invention.

1. A method of controlling a kiln for drying a charge of lumber, the method including: monitoring one or more conditions associated with the operation of the kiln when drying the charge of lumber; and in response to a predetermined change in the one or more monitored conditions, controlling the operation of the kiln by adjusting one or more kiln drying parameters in a manner predetermined by the nature of the change.

2. A method as claimed in claim 1, wherein the one or more monitored conditions include at least one of ambient temperature, ambient humidity, ambient solar radiation, ambient light intensity, ambient wind speed, ambient barometric pressure, kiln temperature, kiln humidity, kiln air circulation speed, moisture content within the charge of lumber, and drying rate of the charge of lumber.

3. A method as claimed in claim 1, wherein the one or more kiln drying parameters include at least one of prescribed kiln temperature, prescribed kiln humidity, prescribed kiln over-temperature limit, prescribed kiln air circulation speed, and prescribed target drying rate.

4. A method as claimed in claim 1, wherein prescribed values for the predetermined change and the one or more kiln drying parameters are represented in one or more tables in which the prescribed values can be stored and from which the prescribed values can be retrieved.

5. A method as claimed in claim 1, wherein the adjusting of the one or more kiln drying parameters includes switching the operation of the kiln between at least two substantially different phases, each phase being controlled by one or more prescribed kiln drying parameters to influence the adsorption and/or absorption of moisture by the charge of lumber.

6. A method as claimed in claim 5, wherein the at least two substantially different phases include at least a first drying phase and at least one of a first equalization phase and a first reconditioning phase, the drying phase being controlled by one or more prescribed kiln drying parameters which promote drying of the charge of lumber, the equalization phase being controlled by one or more prescribed kiln drying parameters which promote reduced drying of and/or increased moisture adsorption by the charge of lumber relative to the drying phase, and the reconditioning phase being controlled by one or more prescribed kiln drying parameters which substantially cease or reverse the drying of the charge of lumber so as to facilitate the redistribution of moisture remaining within the charge of lumber.

7. A method as claimed in claim 1, wherein the kiln is a hybrid kiln operable in at least a solar mode in which the kiln operates to dry the charge of lumber substantially solely with heat generated from solar energy and a heated mode in which the kiln operates to dry the charge of lumber substantially solely with heat generated from means other than solar energy, and the adjusting of the one or more kiln drying parameters includes switching the operation of the kiln between the solar mode and the heated mode.

8. A method as claimed in claim 7, wherein the means other than solar energy is a supplementary heating system, the supplementary heating system including at least one of a gas heating system, a steam heating system and an electrical heating system.

9. A method as claimed in claim 7, wherein the kiln is further operable in a multi-mode in which the kiln operates to dry the charge of lumber with heat generated from solar energy or with heat generated from the means other than solar energy or with a combination of heat generated from solar energy and heat generated from the means other than solar energy, and the adjusting of the one or more kiln drying parameters includes switching the operation of the kiln between the multi-mode and at least one of the solar mode and the heated mode.

10. A method as claimed in claim 1, wherein the one or more kiln drying parameters include prescribed target drying rate, prescribed kiln temperature and prescribed over-temperature limit, the prescribed over-temperature-limit being associated with a temperature at which components associated with the kiln may be harmed or the lumber may experience degrade, the prescribed over-temperature limit temperature not being less than the prescribed kiln temperature, and the method further includes allowing the temperature within the kiln to exceed the prescribed kiln temperature to effect a harsher drying rate within the kiln than the prescribed target drying rate and limiting the kiln temperature to at or below the over-temperature limit.

11. A method as claimed in, claim 1 wherein the one or more kiln parameters include prescribed target drying rate, the one or more monitored conditions include drying rate of the charge of lumber over one or more predetermined time periods, a respective predetermined maximum drying rate is associated with each of the one or more time periods, and the method further includes changing or allowing to change a drying condition within the kiln to effect a harsher drying rate within the kiln than the prescribed target drying rate when the drying rate of the charge of lumber does not exceed the maximum drying rate corresponding to each of the one or more time periods, and changing the kiln drying parameters to slow or reverse the drying of the charge of lumber when the drying rate of the charge of lumber over each of the one or more time periods exceeds the corresponding maximum drying rate.

12. A method as claimed in claim 11, wherein the one or more time periods and the corresponding maximum drying rates are represented in one or more data tables in which the one or more time periods and corresponding maximum drying rates can be stored and from which the one or more time periods and associated maximum drying rates can be retrieved.

13. A method as claimed in, claim 1 wherein the one or more kiln drying parameters include prescribed kiln air circulation speed the one or more monitored conditions include a case moisture content of the charge of lumber, the case moisture content being indicative of the moisture content at or near an outer part of at least one sample section of lumber of the charge, and the method further includes adjusting the operating speed of a fan promoting a drying airflow within the kiln to control the kiln air circulation speed and thereby control the case moisture content of the charge of lumber during drying.

14. A method as claimed in claim 13, wherein the operating speed of the fan is adjusted when switching phases.

15. A method as claimed in claim 1, wherein the one or more monitored conditions include the moisture content within the charge of lumber, and the moisture content within the charge of lumber includes a core moisture content and a case moisture content, the core moisture content being indicative of the moisture content at or near an inner part of at least one sample section of lumber of the charge and the case moisture content being indicative of the moisture content at or near an outer part of at least sample one section of lumber of the charge.

16. A method as claimed in claim 15, wherein the adjusting of the one or more kiln drying parameters is in response to a change in the core moisture content, and the adjusting of the one or more kiln parameters promotes a harsher drying condition within the kiln.

17. A method as claimed in claim 15, wherein the adjusting of the one or more kiln drying parameters is in response to a change in the differential between the core moisture content and the case moisture content, and the adjusting of the one or more kiln drying parameters promotes a reduction in the differential between the core moisture content and the case moisture content.

18. A method as claimed in claim 17, wherein the one or more kiln drying parameters include prescribed kiln humidity and prescribed kiln air circulation speed, and the adjusting of the one or more kiln drying parameters to promote a reduction in the differential between the core moisture content and the case moisture content includes at least one of increasing the prescribed kiln humidity and reducing the prescribed kiln air circulation speed.

19. A system for drying a charge of lumber according to the method claimed in claim 1, the system including: a kiln; one or more sensors for sensing the one or more monitored conditions associated with the operation of the kiln when drying the charge of lumber; and a control system for controlling the operation of the kiln and the one or more sensors, the control system being responsive to the one or more sensors, the control system being arranged to recognize the predetermined change in the one or more conditions and to control the operation of the kiln by adjusting the one or more kiln drying parameters in a manner predetermined by the nature of the change.

20. A system as claimed in claim 19, further including memory associated with the control system, the memory arranged for the storage and retrieval of prescribed values for the predetermined change and the one or more kiln drying parameters by the control system.

21. A system as claimed in claim 19, wherein the control system includes a visual display unit for displaying to a kiln operator at least one of the one or more monitored conditions, the predetermined change and the one or more kiln drying parameters, and an operator input unit by which the kiln operator is able to manually adjust at least one of the predetermined change and the at least one of the one or more kiln drying parameters.
